(19) United States
(12) Patent Application Publication
(10) Pub. No.: US 2002/0185636 A1
(43) Pub. Date: Dec. 12, 2002

(54) Lifters

(76) Inventor: Clovis Salomon, Elmont, NY (US)

Correspondence Address: Clovis Salomon, 1898 Virginia Ave., Elmont, NY, 11003, US

(21) Appl. No.: 09/875,851

(22) Filed: Jun. 8, 2001

(51) Int. Cl. B66F 1/00

(52) U.S. Cl. 254/1

(57) ABSTRACT

Lifter is a spiral type of device that will be installed in your car to make your driving easier. It will be commanded electrically or electronically from inside your car on your dashboard. It will be good for changing a tire in an emergency. Protect your car against theft and against tow.

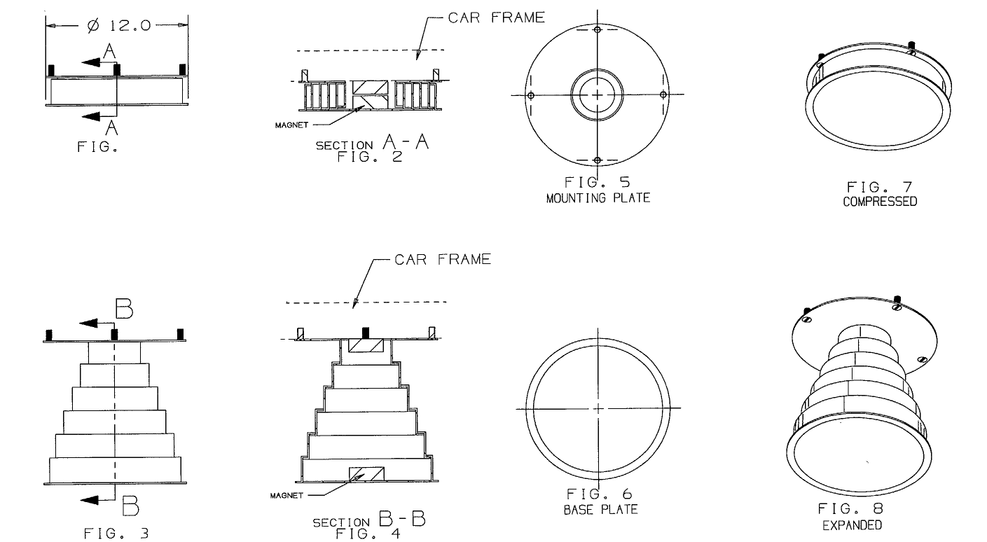

A device that can be installed behind the wheel of a new or used vehicle. It can be operated by manual cranking or by pushing a button to lift a vehicle in case of a flat tire, an emergency, or can be installed on all four wheels as an anti theft device, an anti tow or for storage purposes on a long or short term range.

Having a flat tire is always an embarrassing situation. Finding the right position to jack up a vehicle is a stressful event. Car theft is constantly on the rise and towing a car without the owner's consent happens very often as well. Therefore, putting your car above ground in storage is a good idea. That is where “Lifters” come in.

I claim: The utility for lifter as shown.

When four Lifters are installed beneath your car, if you have a flat tire, you should not worry about changing the tire because, Lifters will jack up your car just by pushing a button on your dashboard, also as an anti theft you can raise all four tires off ground as anti tow protection.

1. What I claim as my invention is a: Fixed in Vehicle jacking system.

2. I claim as my invention: a jacking system permanently installed in Vehicle 4 corners.

3. I claim as my invention: a jacking system built in and or permanently installed underneath of vehicle and functioning independently in four (4) corners
